(19) United States
(12) Patent Application Publication
(10) Pub. No.: US 2002/0185357 A1
(43) Pub. Date: Dec. 12, 2002

(54) Transport conveyor for particulate material

(75) Inventors: Duane Haukaas, Mortlach (CA); Greg Haukaas, Mortlach (CA)

Correspondence Address: ADE & COMPANY, 1700-360 MAIN STREET, WINNIPEG, MB, R3C3Z3, CA

(73) Assignee: Greg Haukaas & Rhonda Haukaas, Mortlach, SK (CA)

(21) Appl. No.: 09/877,175

(22) Filed: Jun. 11, 2001

(51) Int. Cl. B65G 41/00

(52) U.S. Cl. 198/311

(57) ABSTRACT

A transport conveyor particularly for grain in piles on the ground has a trailer mounted on ground wheels for towing by a tractor in a direction of travel. An auger tube is carried on the trailer by a support post which allows the auger tube to swivel about a vertical axis from a longitudinally extending transport position to an operating position in which the tube extends generally transversely of the direction of travel with a feed end of the tube projecting outwardly beyond one side of the trailer, with a discharge end projecting outwardly beyond the opposite side of the vehicle and with the discharge end raised for discharge into a transport truck on that side. The tube can also pivot about a horizontal axis at the post allowing the feed end to float up and down. At the feed end is provided a pick-up or scoop shaped hopper for picking up grain from a grain pile on the ground as the trailer is pulled forwardly. The pick-up hopper can be removed and replaced by a conventional hopper for other uses.

### BACKGROUND OF THE INVENTION

The present device as described in more detail hereinafter is a high capacity grain conveyor designed primarily but not exclusively to pick up from the ground gain piles which have been placed on the ground.

At the present time there is no fully satisfactory way of picking grain piles off the ground. At present the methods of picking up grain from a pile is to stick a conventional auger into the side of a pile and use a bin sweep. This way is very labour intensive, slow and not nice if the weather is bad. The auger will have to be moved several times (by hand) in order to clean up the entire pile. There is also the problem that if only a portion of the pile is picked up by this method the “water shed” properties of the pile will be altered and the grain will spoil. The time taken to fill a 1000 bushel semi-trailer on average is about 1 hour.

Another method now used is to have a conventional grain auger stuck into the pile and use a front end loader to push the grain to the grain auger. This method is easier and faster than a bin sweep but it is very difficult not to get dirt and rocks mixed into the grain. Some feed lots will not buy grain that has been stored on the ground for this reason. Again with this method the water shed is affected if the entire pile is not picked up all at once. The time taken to fill a 1000 bushel semi on average is about 30 to 40 minutes.

### SUMMARY OF THE INVENTION

In view of the foregoing, it is an object of the present invention to provide an improved conveyor which is particularly but not exclusively designed for picking up grain from grain piles on the ground.

According to a first aspect of the invention there is provided a transport conveyor for particulate materials comprising:

a vehicle mounted on ground wheels for movement in a direction of travel;

a transport conveyor duct mounted on the vehicle and arranged such that in an operating position the duct extends generally transversely of the direction of travel with a feed end of the duct projecting outwardly beyond one side of the vehicle, with a discharge end projecting outwardly beyond the opposite side of the vehicle and with the discharge end raised above the feed end;

and a transport conveyor element within the duct for transporting the material from the feed end to the discharge end and for elevating the material to the height of the discharge end for discharge therefrom into a receptacle below the discharge end.

Preferably the vehicle comprises a trailer having a hitch at a forward end and ground wheels behind the hitch so that the device is simple and relatively inexpensive; but the vehicle could also be self propelled.

Preferably the duct is moveable from the operating position to a transport position extending longitudinally of the vehicle and maintained within the width of the vehicle for transport.

Preferably the duct includes a latch construction arranged such the duct is latched in the operating position so as to be held projecting outwardly to each side with sufficient strength and resistance in the latch to allow the duct to accommodate forces from moving forwardly in a pick-up action.

Preferably the duct is rotatable on a support member, such as a post, carried on the vehicle about a vertical axis from the operating position to the transport position.

Preferably also the duct is pivotal on the support member about a horizontal axis allowing the feed end to be raised and lowered possibly in a floating action.

Preferably the vehicle includes a first holder for locating the duct in the transport position and a second holder for locating the duct in the operating position and the duct is moved, either manually or by powered operation to the respective holder by rotating about the vertical axis and dropped into the respective holder by pivoting about the horizontal axis.

Preferably there is provided a receptacle at the feed end and carried thereby for receiving material to be transported and feeding the material to the feed end and, particularly for picking up material from a grain pile, the receptacle is shaped and arranged to act as a pick up for picking up the material from the ground as the receptacle is moved along the ground in the direction of travel of the vehicle. For this purpose, the receptacle preferably has a rear wall, two end walls and an open front and preferably the receptacle has a rotatable member, such as an auger or a brush, therein at front edge for assisting in moving the material which is picked up to the feed end.

Preferably the receptacle is mounted on the feed end for pivotal movement up and down relative to the feed end to follow the ground contour, while the feed end itself can also float on the post.

Preferably receptacle extends from the feed end inwardly therefrom to an inner end free to float upwardly and downwardly relative to the feed end.

For other uses, such as unloading a transport truck on one side transversely across the vehicle into a receptacle such as a rail car on the opposite side, to empty hopper bottom grain bins and fill producer rail road cars, the receptacle is preferably readily removable and replaceable by a conventional hopper.

While the duct is preferably an auger tube containing and auger flight, other types of conveyor can also be used such as belt type conveyor which may pass partly through a tube

The arrangement set out above may allow the operator to be within the controlled environment of his tractor cab away from the dust and the elements of the out doors. Thus the conveyor can be arranged to be pulled behind a tractor through the grain pile on one side and dump into a semi travelling along the opposite side where the farmer will take multiple “slices” along the edge of the grain pile from the comforts of his tractor cab. The auger's “Sweep” or “pick-up” at the lower end of the auger can float and follow the contours of the ground, to clean up the grain with very minimal grain loss and to be at low risk not to pick up dirt and rocks. Because the auger “slices” the edge of the pile when picking up the grain the water shed of the pile is not disturbed. The time taken to fill a 1000 bushel semi on average can be about 7 to 10 minutes.

The device can be used by farmers, grain companies and feed lots who pile grain for temporary storage. It is also reasonable to believe that with a little preparation (pick the rocks) a farmer could dump his grain from the combine on to the ground at one or more pile locations in his field when combining and quickly pick them up at a later time.

### BRIEF DESCRIPTION OF THE DRAWINGS

FIG. 1 is a top plan view of a transport conveyor according to the present invention shown in the operating position.

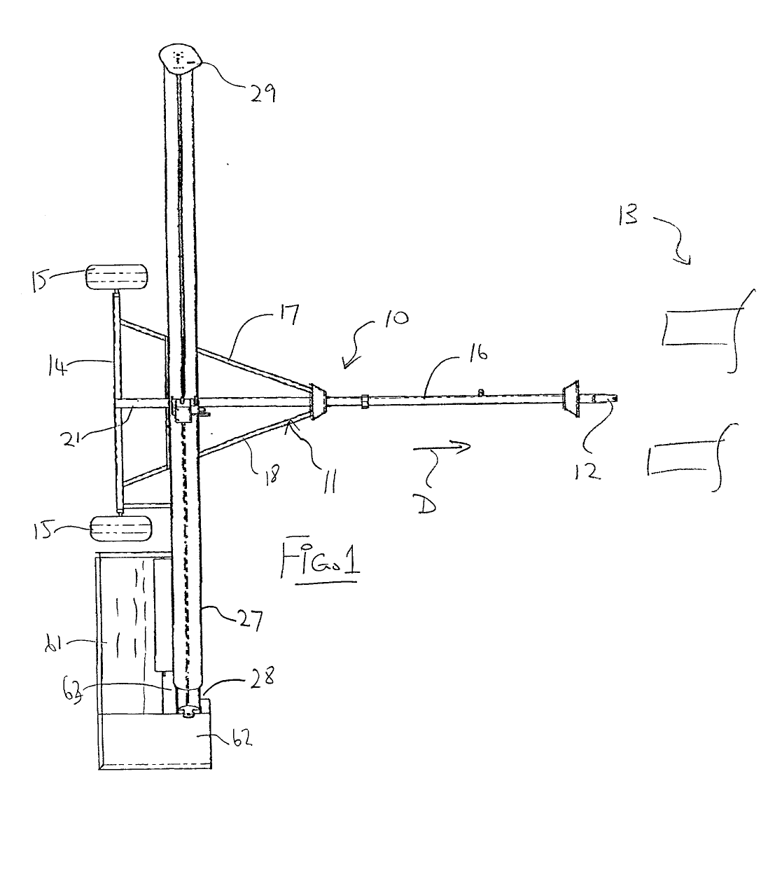

FIG. 2 is a side elevational view of the transport conveyor of FIG. 1 shown in the transport position.

FIG. 3 is an isometric view of the transport conveyor of FIG. 1 shown in the transport position.

FIG. 4 is a front elevational view of the transport conveyor of FIG. 1 shown in the working position and including the rear wheels of the towing tractor.

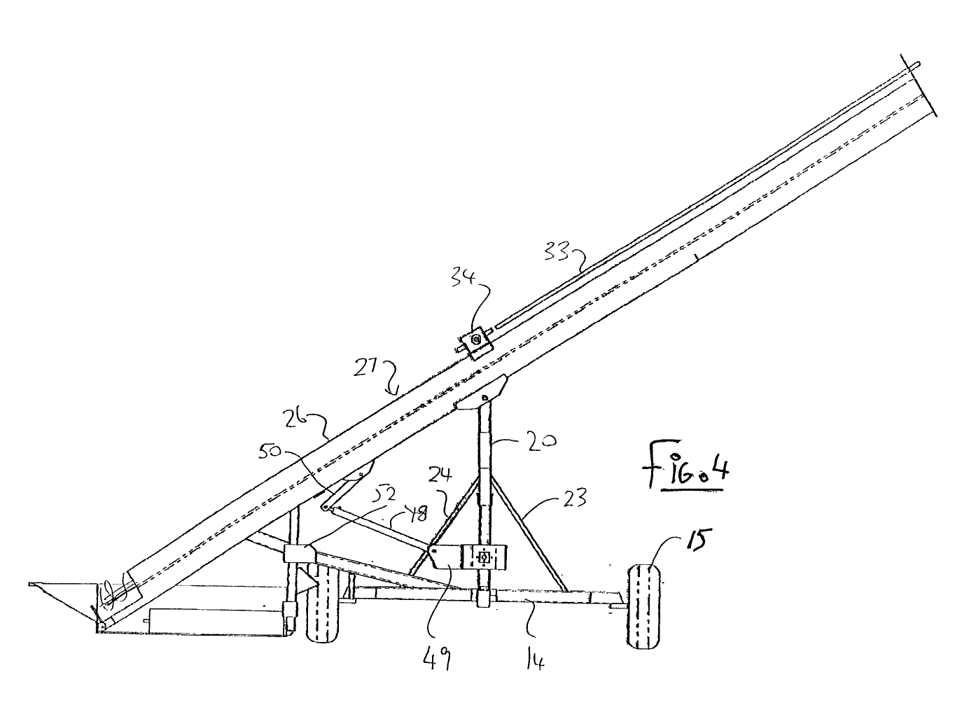

FIG. 5 is a rear elevational view of the transport conveyor of FIG. 1 shown in the working position and including the rear wheels of the towing tractor.

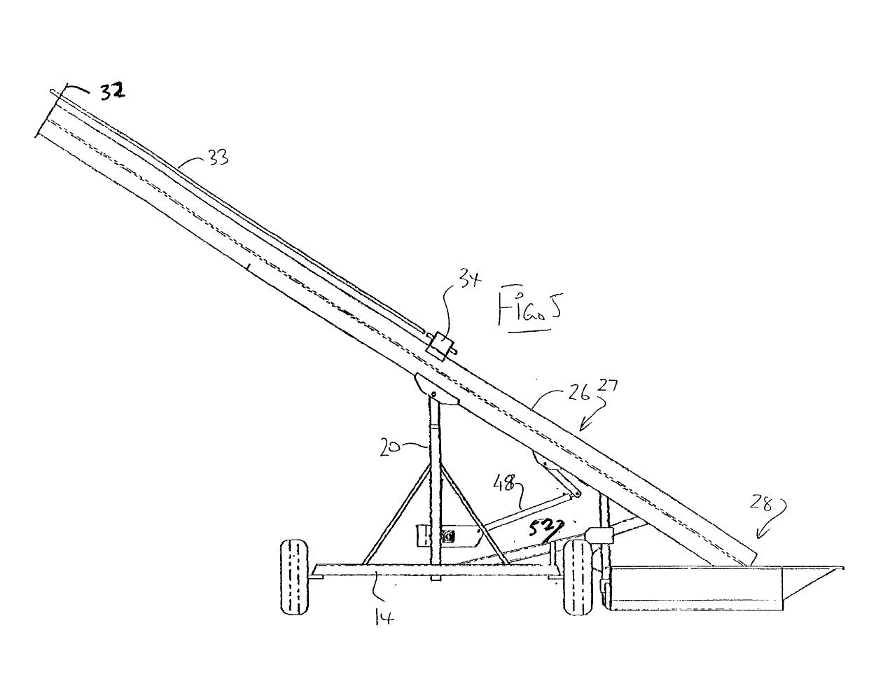

FIG. 6 is an isometric view of the transport conveyor of FIG. 1 shown in the working position.

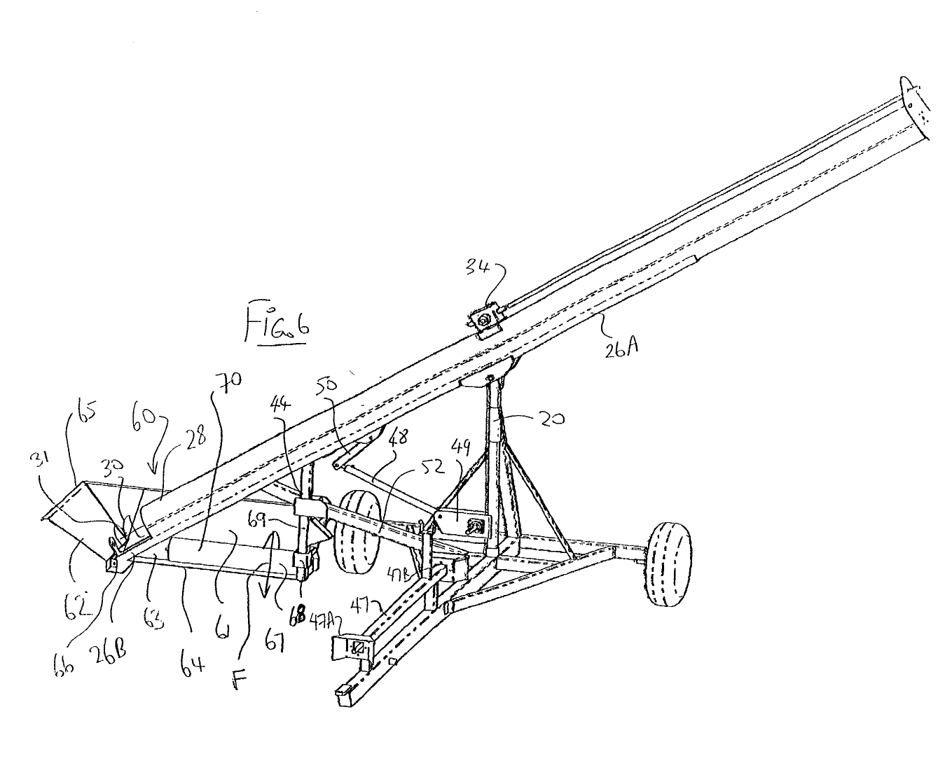

FIG. 7 is a top plan view of the transport conveyor of FIG. 1 shown in the working position and including the rear wheels of the towing tractor and showing the pick-up operating in a grain pile on one side for loading the grain into a truck on the opposite side.

### DETAILED DESCRIPTION

The transport conveyor comprises a trailer 10 having a frame 11 connected to a front hitch 12 towed by a tractor schematically indicated at 13 and including a rear transverse axle 14 attached to ground wheels 15 by which the trailer can be pulled along the ground in a direction D of working movement which is parallel to a main longitudinal beam 16 of the frame 11. The frame further includes two transverse braces 17 and 18 which extend from the main longitudinal beam 16 outwardly and rearwardly to the axle 14 to define a generally triangular structure at the rear of the trailer.

The trailer further includes a main vertical post 20 which is carried on the longitudinal beam 16 at a position spaced forwardly from the axle 14. The post is braced by a main brace 21 extending downwardly and rearwardly from the post and attached to the rear end of the beam 16 at the axle 14. The post is braced against side to side movement by two inclined braces 23 and 24 each of which extends between suitable elements of the frame and in particular as illustrated the brace 21 and the horizontal braces 17 and 18. Thus the post is maintained fixed in a vertical position on the horizontal frame and standing upwardly therefrom to an upper end 25.

At the upper end is mounted the conveyor duct 26 of a conveyor 27 which is as illustrated an auger tube having a feed end 28 and a discharge end with a spout 29. Within the auger tube is mounted an auger flight 30 carried on a shaft 31 which extends to a drive end 32 at the upper discharge end 29. The drive 32 receives drive from a shaft 33 extending along the top of the tube 26 from a gearbox 34 located on top of the tube 26 at the post 20. The gearbox 34 is driven via a drive connection (not shown) from a power take off PTO of the tractor at or adjacent the hitch 12. The drive from the PTO of the tractor to the gearbox 34 includes a drive shaft extending along a beam 47 from a forward end 47A at the PTO to a rearward end 47B where there is provided a link (not shown) between the rearward end 47B and the gearbox 34. Suitable drive connections are well know to one skilled in the art and therefore will not be described in detail herein.

The tube 26 is mounted on a swivel coupling 36 at the upper end 25 of the post 20 so that the tube can swivel around a vertical axis 37 of the post. The post is located approximately at a midpoint of the tube so that the tube is balanced on the post without excessive cantilever forces in either direction.

The tube 26 is also mounted on a horizontal pivot bracket 40 attached to the swivel 36 so that the tube can pivot about a horizontal axis transverse to the vertical axis 37 and indicated at 41. Thus the feed end 28 of the auger tube can be raised and lowered relative to the post while the discharge end of course also follows the movement in a teeter-totter action.

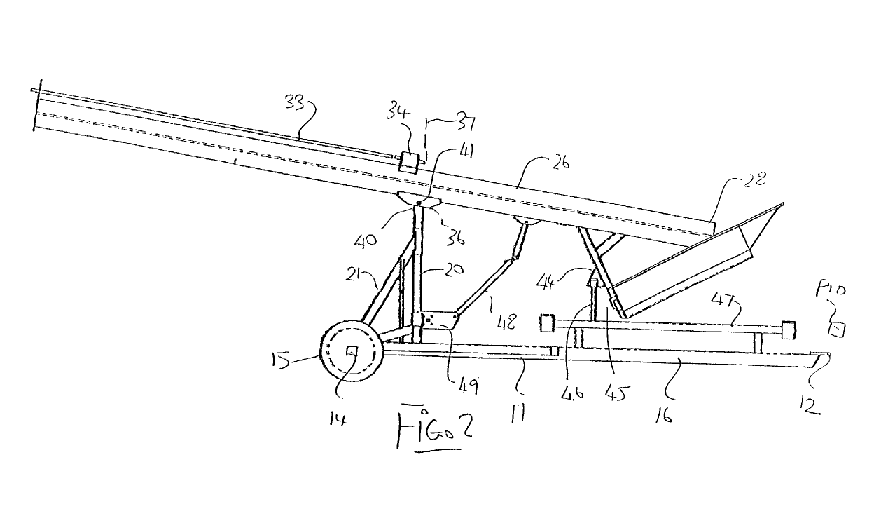

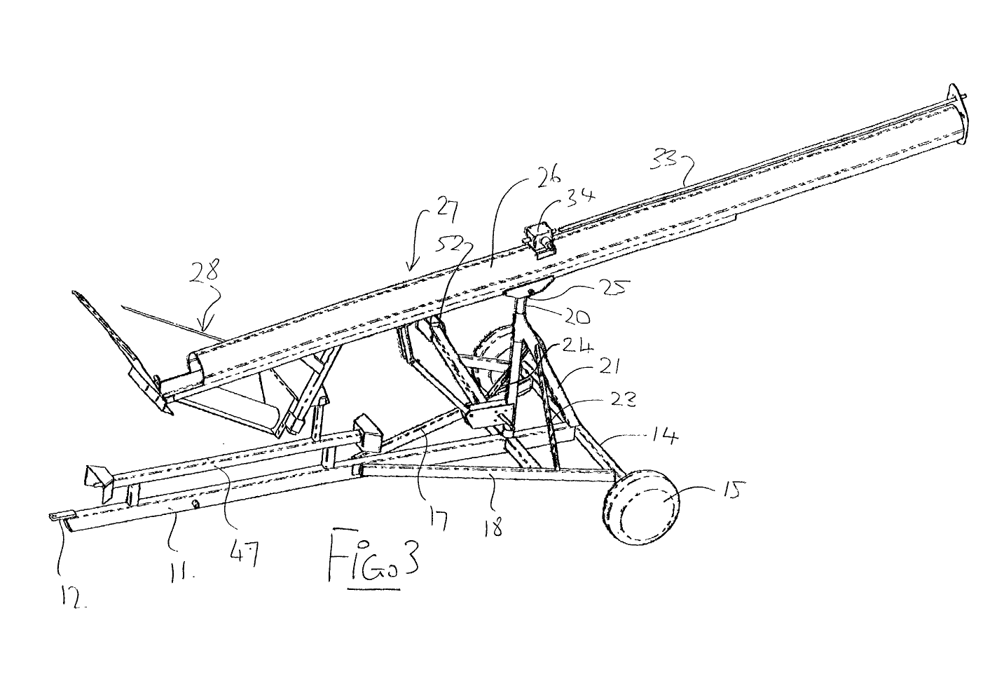

The auger tube can thus be moved about the post from a longitudinal transport position shown in FIGS. 2 and 3 to a transverse operating position shown in the remaining figures. In the longitudinal transport position, the tube lies directly longitudinal of the trailer above the beam 36 and is located in place by a bracket 44 carried in a holder 45 attached to a post 46 on the upper end of a frame 47 on the beam 16. A cylinder 48 can be operated to raise and lower the feed end and is coupled between a bracket 49 at the bottom end of the post and a coupling 50 on the tube so that extension of the cylinder acts to lift the feed end of the tube so that it can be manually swivelled to or from the transport position and can be operated to lower the bracket 44 into the holder 45 thus locating the tube in the transport position. In addition, raising of the auger tube by actuation of the cylinder lifts the bracket 44 out of the holder from the transport position and allows the auger tube to be rotated or swivelled about the post 20 to move it to the operating position in which the auger tube is directly transverse to the trailer or at right angles to the longitudinal position.

In the operating position, the bracket 44 is moved into a holder 52 which is fixed on the frame and extends outwardly to one side so as to hold and locate the auger tube in the working position and prevent it from swivelling about the post 20 in response to forces generated by forward movement of the transport device. Thus the bracket 49 and the bracket 25 swivel on the post 20 so as to allow the cylinder 48 to remain in alignment with the tube allowing the tube to pivot upwardly and downwardly while in a working position under a floating action provided by the cylinder 48 and the link 50.

A pick-up hopper 60 is provided at the end 28 of the auger tube for directing feed material into the flight section 30 exposed on the end of the shaft 31 of the auger. The pick-up hopper 60 includes a rear wall 61 and a side wall 62 and a bottom 63. The rear wall 61 is inclined downwardly and forwardly to the base 63. The side wall 62 is inclined downwardly and inwardly toward the flight 30. A front of the hopper is open so as to define a leading front edge 64 which can slide over the ground to act as a pick up for material at the ground. The hopper includes an upper edge 65 which defines a top horizontal plane of the hopper at which the side and rear walls terminate.

The pick-up hopper 60 is mounted on a stiffener beam 26A of the tube 26 which extends along the bottom of the tube and includes an end portion 26B projecting beyond the end 28 of the tube and providing a support for bottom bearing of the shaft 31. At the bottom end of the beam 26A is provided a transverse pivot mount 66 which is attached to the base 63 of the hopper at the bottom of the side wall 62. Thus the pick-up hopper can pivot about an axis transverse to the length of the auger tube and located at the bottom of the auger tube at the end of the beam portion 26B. Thus the pick-up hopper remains attached to the lower end of the auger tube an inner end 67 opposite to the end wall 65 can move upwardly and downwardly in a floating action as indicated at the arrow F. Movement of the inner end of the pick-up hopper is guided by a sleeve 68 carried on a post 69 on which the bracket 44 is mounted. Thus the inner end of the hopper is prevented from moving rearwardly so that it remains in the plane of the auger tube but the inner end can float upwardly and downwardly as indicated at the arrow F by pivotal movement about the mounting 66.

The bottom 63 includes suitable skid plates so that it can slide over the ground. As the ground contour changes, the outer end of the hopper at the mounting 66 can move upwardly and downwardly by pivotal action of the whole auger tube and the inner end can move upwardly and downwardly independently of the outer end by the floating action F.

At the bottom 63 of the hopper is provided a rotary drive member 70 preferably in the form of an auger flight which rotates about a horizontal axis parallel to the bottom 63 in a direction to sweep material in the pick-up hopper along the bottom towards the outer end for collection by the flight 30.

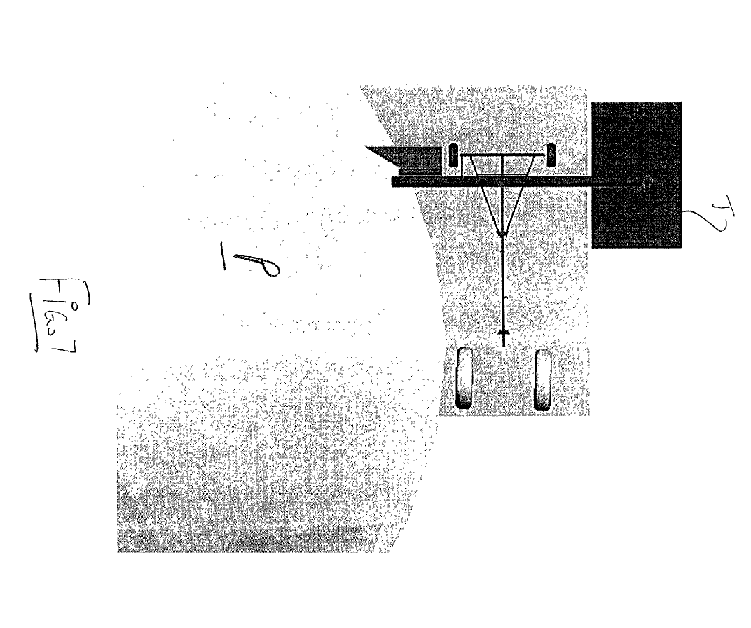

In operation as shown in FIG. 7, the conveyor is towed by the tractor across the edge of a grain pile P so that the pickup hopper is pulled into the edge of the grain pile and the grain enters over the front edge 64 into the pickup hopper and onto the bottom to be swept by the rotary auger flight 70 into the flight 30 for transport through the auger tube to the discharge end where it can be loaded into a truck T. Normally the device will be operated in a position so that it bites a significant chunk from the pile so that the hopper is maintained stationary at a particular location in the pile until the material at that location is discharged into the hopper and through the tube so as to load the truck T. Once the hopper at that position has unloaded the material available to it, the device is moved forwardly so as to take another bite from the pile allowing the device to be maintained stationary again for a period of time sufficient to discharge a further portion of the material from the pile. In the event that the pile relatively small, the device can be moved continuously through the pile so as to sweep the material into the hopper. Where the pile is large and high, the movement in steps is desired to avoid the driver of the tractor from having to ride the clutch to move the vehicle slowly forwardly. It is preferred that the device stops and moves periodically so as to take significant chunks of the pile at each location.

However the open front face of the hopper allows the hopper to act as a pick-up as the device is moved forwardly and the transverse orientation of the auger tube allows the material to be transported from the pick-up on one side of the trailer to the discharge end on the other side of the trailer for loading the truck T.

The mounting bracket 66 includes a readily removable mounting pin which can be pulled to remove the pick-up hopper 60. The hopper can then be replaced by a conventional open top hopper with two sides and two ends so that it acts as a conventional hopper for receiving material poured into the hopper from above. This arrangement can thus allow the device to be used for other purposes than simply picking up from the grain pile and in particular can be used to transfer material from a discharging outlet on one side of the conveyor to a loading position on the other side of the conveyor. This can be used for example to load from a discharging vehicle such as a truck on one side into a bin or into a pile or into a rail car on the other side.

The rotation of the auger tube from the longitudinal transport position into the transverse operating position allows the device to remain attached to the tractor so that it can be readily towed from place to place while the movement of the operating position conveniently locates the feed end on one side of the trailer and the discharge end on the other side of the trailer.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A transport conveyor for particulate materials comprising:
a vehicle mounted on ground wheels for movement in a direction of travel;
a transport conveyor duct mounted on the vehicle and arranged such that in an operating position the duct extends generally transversely of the direction of travel with a feed end of the duct projecting outwardly beyond one side of the vehicle, with a discharge end projecting outwardly beyond the opposite side of the vehicle and with the discharge end raised above the feed end;
and a transport conveyor element within the duct for transporting the material from the feed end to the discharge end and for elevating the material to the height of the discharge end for discharge therefrom into a receptacle below the discharge end.

2. The conveyor according to claim 1 wherein the vehicle comprises a trailer having a hitch at a forward end and ground wheels behind the hitch.

3. The conveyor according to claim 1 wherein the duct is moveable from the operating position to a transport position extending longitudinally of the vehicle and maintained within the width of the vehicle.

4. The conveyor according to claim 3 wherein the duct includes a latch construction arranged such the duct is latched in the operating position.

5. The conveyor according to claim 3 wherein the duct is rotatable on a support member carried on the vehicle about a vertical axis from the operating position to the transport position.

6. The conveyor according to claim 5 wherein the duct is pivotal on support member about a horizontal axis allowing the feed end to be raised and lowered.

7. The conveyor according to claim 6 wherein the vehicle includes a first holder for locating the duct in the transport position and a second holder for locating the duct in the operating position and the duct is moved to the respective holder by rotating about the vertical axis and dropped into the respective holder by pivoting about the horizontal axis.

8. The conveyor according to claim 1 wherein there is provided a receptacle at the feed end and carried thereby for receiving material to be transported and feeding the material to the feed end.

9. The conveyor according to claim 8 wherein the receptacle is shaped and arranged to act as a pick up for picking up the material from the ground as the receptacle is moved along the ground in the direction of travel of the vehicle.

10. The conveyor according to claim 8 wherein the receptacle has a rear wall, two end walls and an open front.

11. The conveyor according to claim 8 wherein the receptacle has a rotatable member therein at front edge for assisting in moving the material which is picked up to the feed end.

12. The conveyor according to claim 11 wherein the rotatable member comprises an auger.

13. The conveyor according to claim 8 wherein the receptacle is mounted on the feed end for pivotal movement up and down relative to the feed end to follow the ground contour.

14. The conveyor according to claim 13 wherein receptacle extends from the feed end inwardly therefrom to an inner end free to float upwardly and downwardly relative to the feed end.

15. The conveyor according to claim 8 wherein the receptacle is readily removable and replaceable by a hopper.

16. The conveyor according to claim 1 wherein the duct comprises a tube and the conveyor element comprises an auger flight.
